(19) United States
(12) Patent Application Publication
(10) Pub. No.: US 2009/0132715 A1
(43) Pub. Date: May 21, 2009

(54) SYSTEM AND METHOD FOR CONDUCTING SECURE IP TRANSACTION SESSIONS WITH PERSISTENCE

(75) Inventors: Devarajan Puthupparambil, Rolling Meadows, IL (US); J. Schneider, Grayslake, IL (US)

Correspondence Address: UTSTARCOM, INC., 3800 GOLF ROAD, SUITE 220, ROLLING MEADOWS, IL, 60008, US

(73) Assignee: UTStarcom, Inc., Alameda, CA (US)

(21) Appl. No.: 11/972,067

(22) Filed: Jan. 10, 2008

Related U.S. Application Data
(60) Provisional application No. 60/989,039, filed on Nov. 19, 2007.

(51) Int. Cl. G06F 15/16

(52) U.S. Cl. 709/227

(57) ABSTRACT

A method for providing a persistent network session is disclosed. The method includes conducting a first session between a terminal and a server via a communication gateway. The first session includes a session between the communication gateway and the server. The method also includes issuing a notification to the communication gateway to continue a session between the terminal and the communication gateway upon closure of the first session.

### RELATED APPLICATION

This application claims the benefit of U.S. Provisional Application No. 60/989,039 entitled “SSL Enhancement for Billing of Secure IP Transaction Sessions with Persistence” as was filed on Nov. 19, 2007, and bearing Attorney's Docket Number 5470, the contents of which are fully incorporated herein by reference.

### BACKGROUND

The invention relates generally to secure, electronic transactions over an Internet Protocol based session, and more specifically, to a system and method for conducting a secure transaction with persistence over an Internet Protocol based communication network.

Secure transactions over public Internet Protocol (IP) networks, between Internet Protocol Point-of-Sale (IP POS) terminals and host servers are made possible by aggregating Secure Sockets Layer (SSL) connections from IP POS terminals and routing them to the host servers. This operation is performed by a transaction gateway.

Generally, a transaction gateway offers the feature of persistent connections between the IP POS terminals and the transaction gateway system to enable faster and quicker connection of the SSL sessions. This is performed in order to facilitate quicker completion of transactions successfully. In such scenarios, time is a critical factor while transaction processing is in progress, because it dictates the number of transactions that can be completed over a period. Moreover, the amount of time consumed also determines the resources required for processing a given number of transactions within a specific time.

While using persistence between the IP POS terminals and a transaction gateway, with POS specific protocols used for transactions, there is lack of a clear method for identifying the end of a secure SSL session, so that billing records can be transmitted. Currently, the end of the session is marked by a unidirectional “Encrypted Alert” message with alert description of “close-notify” which is a notification for closing the session followed by closing the Transport Layer connection. This inhibits the mode of persistent operation between the IP POS terminals and the transaction gateway system, with the knowledge and agreement of the IP POS terminals and the transaction gateway system. Furthermore, this prolongs the session for a longer duration, thereby demanding more resources and limiting the number of transactions that can be conducted over a given period.

Therefore, there exists a need for a technique to identify the end of a secure session, so that billing records can be transmitted promptly while maintaining a persistent Transmission Control Protocol (TCP) connection.

### SUMMARY

According to one aspect of the present technique, a method for providing a persistent network session is disclosed. The method includes conducting a first session between a terminal and a server via a communication gateway. The first session includes a session between the communication gateway and the server. The method also includes issuing a notification to the communication gateway to continue a session between the terminal and the communication gateway upon closure of the first session.

According to another aspect of the present technique, a method for conducting multiple call sessions is provided. The method includes conducting a first call session between an IP POS terminal and a host server via a communication gateway, where the first call session includes a session between the communication gateway and the host server. The method also includes exchanging a closure message between the IP POS terminal and the communication gateway on completion of the first call session, where the closure message includes a notification to the communication gateway to continue a session between the IP POS terminal and the communication gateway upon closure of the first call session. Further, a billing session for the first call session is also included. Systems describing the methods are also included.

### BRIEF DESCRIPTION OF THE DRAWINGS

These and various other features, aspects, and advantages of the present invention will become apparent when the following detailed description is read with reference to the accompanying drawings in which like characters represent like parts throughout the drawings, wherein:

FIG. 1 is a schematic diagram of an exemplary communication platform, in accordance with aspects of the present technique;

FIG. 2 is a flow diagram illustrating an exemplary method of operation of the communication network of FIG. 1, in accordance with aspects of the present technique; and

FIG. 3 is a call flow diagram illustrating the persistence of TCP connection, when the SSL session is closed, in accordance with various embodiments of the present technique.

### DETAILED DESCRIPTION OF EXEMPLARY EMBODIMENTS

In the subsequent paragraphs, an approach for providing a persistent network connection between an Internet Protocol Point-of-Service (IP POS) terminal and a host server will be explained in detail. The approach described hereinafter describes a technique for maintaining a session even after a first call session is over, so that a second call session can be begun seamlessly. While the IP POS terminal may be defined as a transaction terminal facilitating different types of electronic transactions, it may include, in one embodiment, a Point-of-Sale terminal that is commonly used to retail credit or debit transactions. The transactions performed over the IP POS terminals and the Internet Protocol (IP) based network, which broadly includes a communication gateway and a host server, are processed in a secure manner through the use of various IP protocols, transaction protocols, and, security or authentication and authorization protocols. As will be appreciated by those of ordinary skill in the art, the technique is applicable to various systems that perform a secure transaction when conducted in conjunction with an IP-based network. Indeed, the exemplary uses and implementations described herein are merely provided as examples to facilitate understanding of the presently contemplated techniques. Therefore, the various aspects of the present technique will be explained, by way of examples only, with the aid of figures hereinafter.

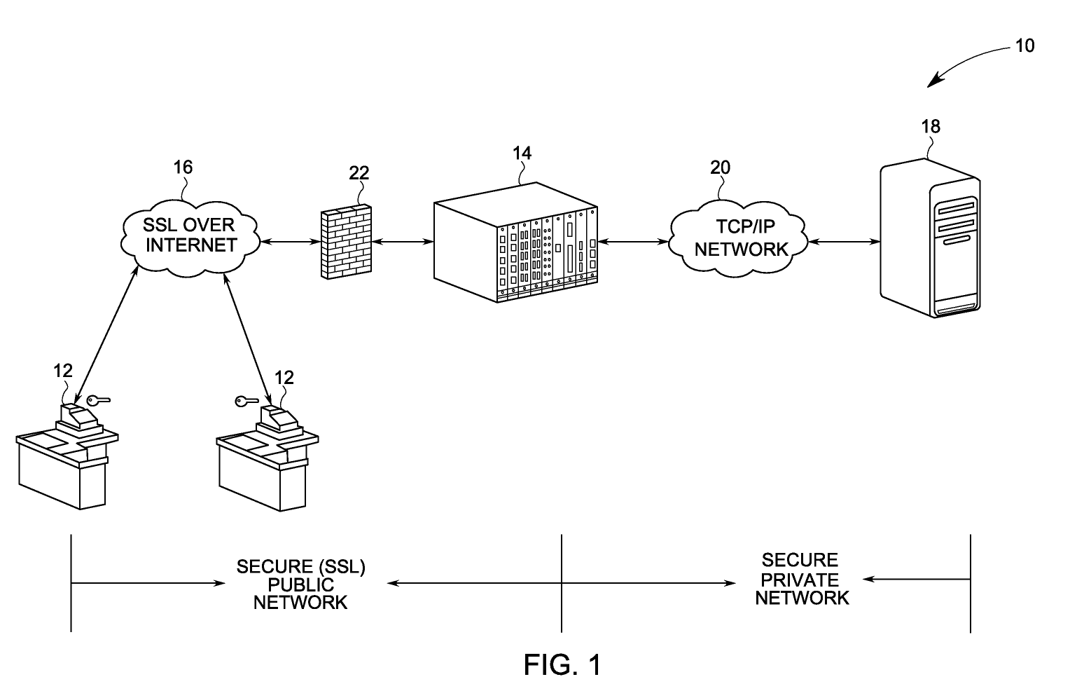

Referring generally to FIG. 1, the transaction process will be described by reference to an exemplary communication platform designated generally by numeral 10. It should be appreciated however, that the communication platform 10 may find application in a range of settings and systems, and that its use in transaction process described herein is but one such application. As will be explained in detail, the communication platform 10 is employed in various kinds of applications ranging from simple POS transactions to more complex communications, such as for example, a secure access, a secure message exchange between two devices, and the like.

The communication platform 10 includes many terminals 12, such as IP POS transaction terminals, deployed at various establishments, such as shops. Each of the IP POS transaction terminals 12 is capable of accepting or performing a financial transaction through a credit card, a debit card, or any such financial instrument as may be contemplated by one of ordinary skill in the art. Similarly, the terminal 12 is also capable of handling other transactions such as a secure access or a secure message exchange. Each of such terminals 12 is linked with a transaction gateway or a communication gateway 14 through a secure public network, such as but not limited to a Secure Sockets Layer (SSL) network over the Internet 16 or an Internet Protocol Security (IPSec) connection. The exemplary communication gateway 14 may comprise a Layer 3 Internet Protocol connection aggregation apparatus, for example, a Layer 3 aggregation and transaction protocol engine. Various transaction protocols, which may include at least one host-compatible transaction protocol, may be used to couple the plurality of terminals 12. This communication gateway 14 is preferably configured to convert an incoming communication that uses a certain transaction protocol into an aggregated outgoing communication that uses the host-compatible transaction protocol. Therefore, it serves to facilitate compatible communication exchanges between multiple end users (such as various IP POS terminals 12) and, for example, an authorization host.

Many such communication gateways 14 are further linked to a host server 18 over a secure private network, such as via a simple socket connection like Transmission Control Protocol (TCP) socket connection or a Transmission Control Protocol/Internet Protocol (TCP/IP) network 20, as illustrated. The host server 18 may similarly include a host socket connection, which links to the communication gateway 14 and facilitates provision of the abovementioned outgoing communication that is aggregated with respect to Layer 3. Those skilled in the art would recognize that a range of other IP protocols or socket connections may be utilized, such as but not limited to Network Time Protocol (NTP), User Datagram Protocol (UDP), Domain Name System (DNS), Lightweight Directory Access Protocol (LDAP), Routing Information Protocol (RIP) and it IP versions of RIP, RIPv1, RIPv2, and RIPng, Open Shortest Path First (OSPF), as presently known, or others hereafter developed. In one embodiment, there is optionally a firewall 22 deployed between the terminal 12 and the communication gateway 14. This firewall 22 can include software or hardware implementations.

The transaction protocols supported by the transaction gateway or the communication gateway 14 in order to conduct a transaction includes VISAI (EIS 1051), VISAII (EIS 1052), ISO 8583, Transport Protocol Data Unit (TPDU), Transparent protocol, and, various custom protocols as are known in the art to facilitate interaction between host servers 18 and terminals 12.

In an exemplary transaction, when a card holder makes a payment at a merchant establishment, the card may be swiped with a retail IP POS terminal 12. A first secure (SSL) call session or a first secure session is initiated by the terminal 12 with a communication gateway 14 to which the terminal is coupled. The communication gateway 14 links the IP POS terminal 12 to a host server 18, via a TCP socket connection, for instance. Once the first call session is completed, a closure message is transmitted by the IP POS terminal 12 to the communication gateway 14. The closure message also includes a notification to the communication gateway 14 to continue a session or link between the IP POS terminal 12 and the communication gateway even after the closure of the first call session. A closure message response is sent by the communication gateway 14 to the IP POS terminal 12. This closure message response also comprises a notification response to continue the session with the IP POS terminal 12 and the communication gateway 14. This session or link that is retained between the communication gateway 14 and the IP POS terminal 12 after the closure of the first secure (SSL) call session may include the TCP socket connection. A billing session for the first call session may follow the closure of the first call session. The session that is maintained for a period of time in a persistent mode after the first call session facilitates conducting a second call session in a similar manner as the first call session. It may however be noted that the closure message or the closure message response, which may each include an encrypted alert message with notification for persistence (Encrypted Alert (with notify-persist)), may be similar in format. Furthermore, the closure message, such as an Encrypted Alert (with notify-persist), may be initiated by the terminal 12 wherein the communication gateway 14 responds with a closure message response, such as an Encrypted Alert (with notify-persist), or may be initiated by the communication gateway, in which case, the terminal responds with a closure message response.

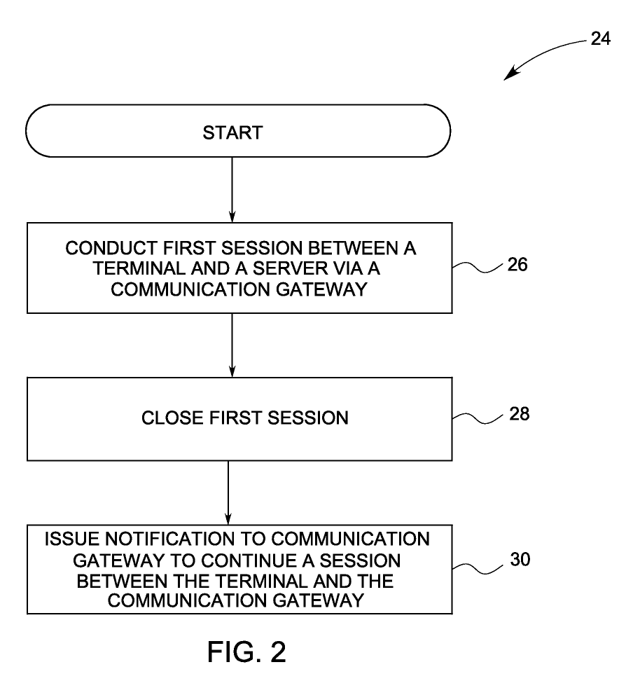

The functioning of the communication platform 10 will become better understood when described in conjunction with FIG. 2, which illustrates a flow diagram 24 for an exemplary method of operation of the communication platform. A first session or a first call session is conducted 26 between a terminal 12, which in certain embodiments may include a transaction terminal such as an IP POS transaction terminal, and, a server 18 such as a host server. The first session is conducted via a communication gateway 14 such that the terminal 12 initiates the transaction or the first call session with the communication gateway within a secure public network like an SSL based network 16 or a secure socket connection, and the communication gateway further links with the server 18 through a secure private network such as a TCP/IP network 20. Once the first SSL session is closed 28 or the transaction terminates, a notification message is issued 30 to the communication gateway 14 by the terminal 12, in one embodiment. However, such notification message may be issued 30 by the communication gateway 14 to the terminal 12 in other embodiments. As noted earlier, the notification message may be issued 30 in the form of an Encrypted Alert message comprising a notify-persist signal. Further, once the Encrypted Alert message is received by the communication gateway 14 or the terminal 12, the recipient may issue a response in similar format, such as for example, Encrypted Alert message comprising a notify-persist signal. This message notifies the IP POS terminal 12 and the communication gateway 14 to continue maintaining the TCP connection with each other in a persistent mode.

A billing session may proceed after the notification is issued by both elements. However, as indicated by the notification signal, a socket connection, such as an IP POS socket connection may be retained by the communication gateway 14 between the communication gateway and the IP POS terminal 12. This facilitates initiation of a second SSL session or a second SSL call session by the terminal 12 with the other network elements (communication gateway 14 and server 18) in a seamless manner.

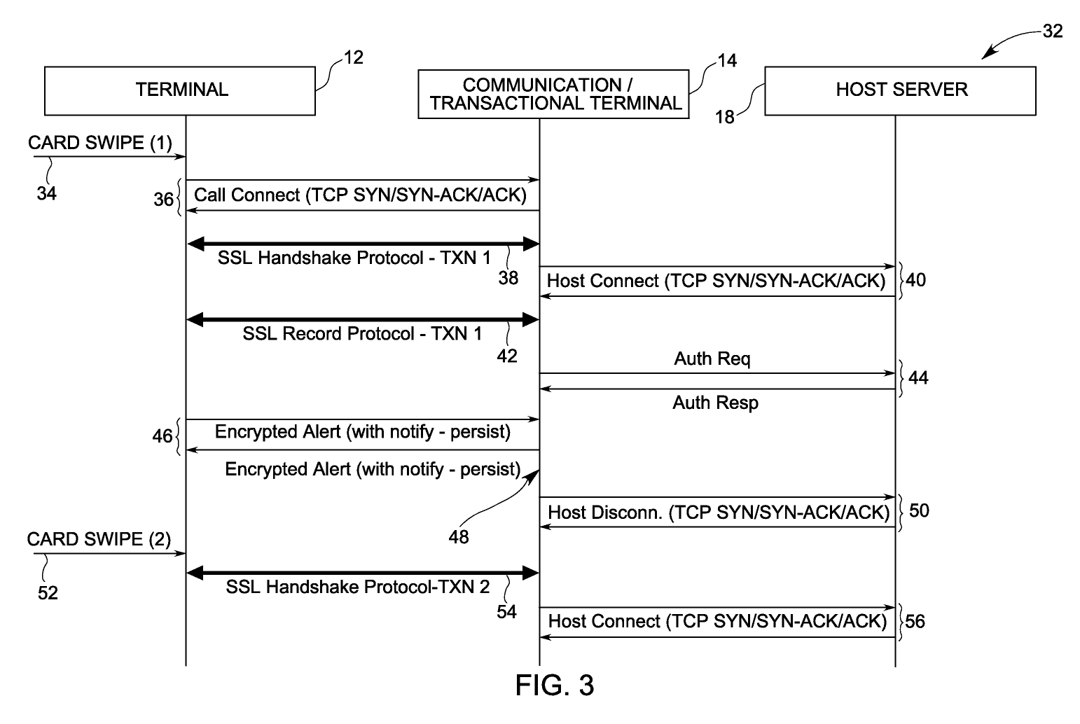

Turning now to FIG. 3, the technique will be explained with reference to an exemplary call flow diagram 32 illustrating the persistence of TCP connection when the SSL session is closed in the communication platform 10 of FIG. 1. As previously mentioned, the communication platform 10 includes a terminal 12, a communication gateway 14, and, a server 18. When a card, for example a credit or debit card, is swiped 34, generating an external input, or, a transaction (first call session or first session) is initiated by the transaction terminal or IP POS terminal 12, the transaction terminal 12 establishes 36 a session with the communication gateway 14 using, in one embodiment, a Call Connect signal with TCP SYN, SYN-ACK, and, ACK messages. In other embodiments, other similar messages may be used to establish the session. A handshake session, such as an SSL handshake protocol session, is undertaken 38 in order to establish a secure (SSL) connection between the terminal and the communication gateway 14. This handshake session forms the first layer of the SSL connection. The communication gateway 14 now establishes 40 a host socket connection with the host server 18, via, in one embodiment, a Host Connect signal with TCP SYN, SYN-ACK, and, ACK messages. In the second layer of the SSL connection, an SSL Record Protocol Transaction session is conducted 14 between the terminal 12 and the communication gateway 14.

An authentication session is undertaken 44 between the communication gateway 14 and the host server 18. In one embodiment, an Authentication Request (Auth Req) is sent by the communication gateway 14 to the host server 18, which responds with an Authentication Response (Auth Resp). Together, the Authentication Request and the Authentication Response constitute the authentication session. A closure message and a closure message response are exchanged 46 between the terminal 12 and the communication gateway 14. This is performed in order to conclude the SSL session between the terminal 12 and the communication gateway 14. As earlier stated, the closure message may be initiated by either the terminal 12 to the communication gateway 14 or vice-versa, in the format Encrypted Alert (with notify-persist). In either case, the recipient (communication gateway 14 and terminal 12, respectively) responds with a closure message response in the format Encrypted Alert (with notify-persist) to the initiator (terminal 12 and communication gateway 14, respectively). The first SSL call session is now closed as generally indicated by arrow 48. Once the first SSL call session is closed, billing session for the first session may follow. The transport layer connection, for example TCP in one embodiment, between the terminal 12 and communication gateway 14 is retained. The host server 18 may now be disconnected 50 via a Host Disconnect signal with TCP FIN, FIN-ACK messages. Those of ordinary skill in the art will recognize that such a procedure obviates the need for a Call Disconnect message exchange between the terminal 12 and the communication gateway 14.

A second SSL session or a second SSL call session or a second transaction session may be initiated by performing a card swipe 52 in a manner previously described. The card swipe 52 may be followed directly by the first layer of the SSL connection, such as the SSL handshake protocol session 54, eliminating the need for a Call Connect message exchange. Similarly, a Host Connect signal may be exchanged 56 between the communication gateway 14 and the host server 18. It may be noted that the after the second card swipe 52, the procedure in this embodiment follows the same steps as in the case of the first card swipe 34 except that the Call Connect signal may not be exchanged. In other words, in the case of the second session, the procedure directly jumps to establishment 54 of the first layer of the SSL connection, and, therefore steps 38 and 54 are analogous. Similarly, this is followed by message steps analogous to steps 40 through 50.

While only certain aspects of the invention have been illustrated and described herein, many modifications and changes will occur to those skilled in the art. It is, therefore, to be understood that the appended claims are intended to cover all such modifications and changes that fall within the true spirit of the invention.

1. A method for providing a persistent network session, the method comprising:
conducting a first session between a terminal and a server via a communication gateway, the first session comprising a session between the communication gateway and the server; and
issuing a notification to the communication gateway to continue a session between the terminal and the communication gateway upon closure of the first session.

2. The method of claim 1, further comprising:
initiating a second session between the terminal and the server via the communication gateway.

3. The method of claim 1, wherein conducting the first session comprises initiating the session between the terminal and the communication gateway.

4. The method of claim 1, wherein conducting the first session comprises providing a handshake session between the terminal and the communication gateway.

5. The method of claim 1, wherein conducting the first session comprises providing an authentication session between the communication gateway and the server.

6. The method of claim 1, wherein issuing the notification comprises issuing a closure message comprising the notification.

7. The method of claim 1, wherein issuing the notification comprises closing the first session.

8. The method of claim 1, wherein issuing the notification comprises initiating a billing session, in accordance with the first session, through the communication gateway.

9. A method for conducting multiple call sessions, the method comprising:
conducting a first call session between an transaction terminal and a host server via a communication gateway, the first call session comprising a session between the communication gateway and the host server;
exchanging a closure message between the transaction terminal and the communication gateway on completion of the first call session, the closure message comprising a notification to the communication gateway to continue a session between the transaction terminal and the communication gateway upon closure of the first call session; and
generating a billing session for the first call session.

10. The method of claim 9 further comprising:
exchanging a closure message response between the communication gateway and the transaction terminal comprising a notification response to continue the session with the transaction terminal, the communication gateway and the transaction terminal retaining a socket connection in a persistent mode for performing a second call session.

11. The method of claim 9, wherein issuing the closure message comprises disconnecting the host server from the communication gateway.

12. The method of claim 9 comprising initiating a second call session between the transaction terminal and the host server, via the communication gateway, over a persistent Transmission Control Protocol (TCP) session between the transaction terminal and the communication gateway.

13. An Internet Protocol network element comprising:
a communication gateway communicatively coupled to at least one transaction terminal and a host server, wherein the at least one transaction terminal is configured to initiate a first session between the at least one transaction terminal and the host server and wherein the communication gateway is configured to receive a notification message from the at least one transaction terminal, the notification message configured to maintain a session between the at least one transaction terminal and the communication gateway upon closure of the first session.

14. The Internet Protocol network element of claim 13, wherein the at least one transaction terminal comprises a Point-of-Service transaction terminal.

15. The Internet Protocol network element of claim 13, wherein the at least one transaction terminal is configured to initiate a transaction via accepting an external input.

16. The Internet Protocol network element of claim 13, wherein the at least one transaction terminal is communicatively coupled to the communication gateway over a secure public network.

17. The Internet Protocol network element of claim 13, wherein the at least one transaction terminal is communicatively coupled to the communication gateway via at least one secure socket connection.

18. The Internet Protocol network element of claim 17, wherein the at least one secure socket connection comprises a socket connection compatible with at least one of Secure Sockets Layer (SSL) and Internet Protocol Security (IPSEC) secure connection.

19. The Internet Protocol network element of claim 13, wherein the transaction terminal and the communication gateway are configured to exchange a closure message comprising the notification message, the notification message configured to maintain the session for a period of time, in a persistent mode.

20. The Internet Protocol network element of claim 13, wherein the host server is communicatively coupled to the communication gateway over a secure private network via a host socket connection, the host socket connection further comprising at least one of a secure Transmission Control Protocol/Internet Protocol (TCP/IP) socket connection, and a non-secure connection.
